(19) United States
(12) Patent Application Publication
(10) Pub. No.: US 2023/0047028 A1
(43) Pub. Date: Feb. 16, 2023

(54) Mobile Legal Counsel System and Method

(71) Applicant: Redmon Jeang LLC, Parker, TX (US)

(72) Inventors: Clayton K. Redmon, Grand Prairie, TX (US); Wei Wei Jeang, Parker, TX (US); Otis B. Jennings, Durham, NC (US)

(21) Appl. No.: 17/975,585

(22) Filed: Oct. 27, 2022

Related U.S. Application Data
(63) Continuation-in-part of application No. 16/892,277, filed on Jun. 3, 2020.
Application No. 16/892,277 is a continuation-in-part of application No. 15/644,524, filed on Jul. 7, 2017, now Pat. No. 11,443,395.
(60) Provisional application No. 62/364,300, filed on Jul. 19, 2016.

(51) Int. Cl. G06Q 50/18; B64C 39/02; H04W 4/029

(52) U.S. Cl. CPC G06Q 50/18; B64C 39/024; H04W 4/029; B64C 2201/127

(57) ABSTRACT

An on-demand mobile lawyer method includes receiving a live consultation request from a user, automatically receiving a live-stream of video images of the user and surroundings and storing the video images, automatically searching a plurality of records associated with a plurality of lawyers stored in a remote database, automatically identifying at least one lawyer licensed in a jurisdiction that corresponds to a current location of the user, automatically transmitting at least one notification to the identified at least one lawyer, live-streaming captured video images of the user for viewing by the identified at least one lawyer, automatically receiving and storing live-streaming video images of the identified at least one lawyer in the remote database, and automatically transmitting the live-streaming video images of the identified at least one lawyer to be displayed on a display screen viewable by the user.

### RELATED APPLICATION

This disclosure is a Continuation-in-Part application of U.S. Non-Provisional application Ser. No. 16/892,277 filed on Jun. 3, 2020, which is a Continuation-in-Part application of U.S. Non-Provisional application Ser. No. 15/644,524 filed Jul. 7, 2017, which claims the benefit of U.S. Provisional Patent Application No. 62/364,300 filed on Jul. 19, 2016.

### FIELD

This disclosure relates to mobile software applications, and more particularly to a mobile legal counsel system and method, so that an attorney can be summoned quickly and virtually whenever a need arises to serve as a third-party observer, help defuse the situation, run interference, and provide legal advice.

### BACKGROUND

According to a U.S. Department of Justice Special Report, in 2011, over 62.9 million U.S. residents had one or more contacts with police. Of these contacts, over 31 million were involuntary, and 13 million are in the context of traffic stops. Relatively more black drivers (13%) than white (10%) and Hispanic (10%) drivers were pulled over in a traffic stop. In these traffic stop incidents, about 1.2 million people felt that the police officer involved did not behave properly. However, only a small fraction, or 4.4% of these people filed a police complaint, and more than 1.1 million people did not. About 19% of persons involved in street stops were searched or frisked by police. The majority of these people did not believe the police had a legitimate reason for the search.

According to data compiled by The Washington Post, white people make up roughly 62 percent of the U.S. population but only about 49 percent of those who are killed by police officers. African Americans, however, account for 24 percent of those fatally shot and killed by the police despite being just 13 percent of the U.S. population. These numbers mean black Americans are 2.5 times as likely as white Americans to be shot and killed by police officers. U.S. police officers have shot and killed the exact same number of unarmed white people as they have unarmed black people: 50 each. But because the white population is approximately five times larger than the black population, unarmed black Americans were five times as likely as unarmed white Americans to be shot and killed by a police officer. https://www.washingtonpost-com/news/post-nation/wp/2016/07/11/arent-more-white-people-than-black-people-killed-by-police-yes-but-no/!utm_term=0.71a68e6da5fe

Some argue that police shooting is racially-based, but there are evidence that show these police officers who commit these atrocities may be motivated by unconscious or implicit bias. There are research studies that support the notion that police professionals use more force, or be quicker to use force, against blacks due to a black-crime implicit bias producing greater perceptions of threat. Studies also support that implicit bias, once recognized, can be counteracted with repeated and intentional training and learning. However, implicit or explicit, the result is still the same — loss of innocent lives.

Whether white or black, implicit or explicit bias, there is a desire to defuse and de-escalate tense situations between the police and members of the general public if the loss of innocent lives can be avoided or reduced.

### DESCRIPTION OF THE DRAWINGS

FIG. 1 is a simplified diagram of an exemplary embodiment of a system and method for mobile legal counsel according to the teachings of the present disclosure;

FIGS. 2-4 are simplified flowcharts of an example of a system and method for mobile legal counsel according to the teachings of the present disclosure.

### DETAILED DESCRIPTION

For many African Americans living in the United States, the threat of police brutality and shooting is an everyday reality. Black parents have “The Talk” with their children not of the birds and the bees, but how they must be obedient and compliant whenever they encounter the police.

Police brutality and killing is a deeply-rooted problem that cannot be easily and quickly addressed without multi-pronged persistent efforts. The concept described herein is an effort to introduce technology as one immediate solution to this problem. This concept uses on-demand technology to introduce the presence of a third party, a licensed attorney, into a police encounter. The licensed attorney can serve as a live observer, witness, and intermediary who can help to de-escalate and defuse the situation.

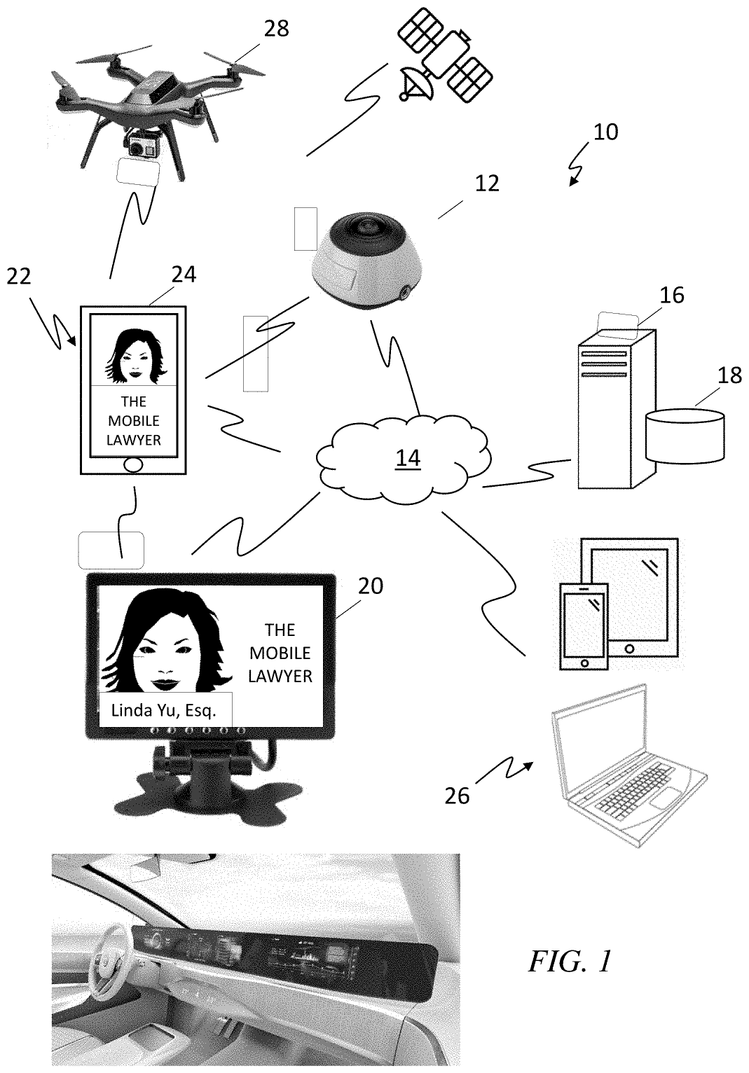

FIG. 1 is a simplified diagram of an exemplary embodiment of a system and method for mobile legal counsel 10 according to the teachings of the present disclosure. The system 10 includes one or more video cameras, which may be one or more OEM or after-market video camera integrated with the vehicle, mounted at one or more points of the interior compartment, or video cameras that are part of the driver's mobile computing device. The video images may be captured by a 360-degree video camera 12 that can live-stream 360 degrees of video data with accompanying audio data over the Internet and/or cellular network 14. The 360-degree camera 12 is preferably high definition and designed for mounting on the dash of a vehicle so that it can capture unobstructed video images of a user seated in the driver's seat as well as the front passenger seat of the vehicle. An example of such a camera is a 1080p sports action camera, Chinavasion product code CVLM-DV141. Alternatively, the 360-degree camera may be mountable to the user's mobile device itself, and utilize its cellular and Internet connectivity to live stream video data. In another alternate embodiment, a mobile device such as a mobile telephone that has one or more built-in video cameras can be employed to capture one or more video streams. In an alternate embodiment, one or more video cameras integrated with and mounted at different points of the user's car, inside and/or outside the passenger compartment, can be used to capture video footage from various vantage points to avoid obstacles that may block the view, such as some parts of the car or passengers in the car. The mobile lawyer app may incorporate images captured by OEM cameras installed on the vehicle. In yet another embodiment, one or more drone-based video camera 28 can be used to augment the live-streamed video data from one or more overhead vantage point. It is contemplated that the drone(s) can be remotely controlled by either the user, a remote administrator, the remote lawyer, or self-guided. The remote administrator and/or lawyer may also be able to remotely control one or more other video cameras mounted inside and/or outside the passenger compartment. One or more video cameras may additionally have infrared capability to capture clear images in low ambient light conditions.

In certain applications, the mobile lawyer app may employ video images captured by cameras native on a mobile device, such as the front and/or back-facing cameras on a mobile telephone. For example, if the mobile lawyer app is initiated and it detects that an externally-mounted 360-degree camera is not available, then it may automatically initiate operation of the built-in cameras on the mobile device.

The captured live-stream video data (including audio) from one or more vantage points are transmitted (using wireless/cellular/satellite connectivity of the mobile device, the camera, the drone, and/or the vehicle) via a global computer network (Internet), cellular mobile telephone network 14, and/or satellite network to one or more remote server 16 and stored in one or more database 18, preferably encrypted to ensure privacy. Alternatively, the user may pre-set a system setting to automatically live stream the video to one or more recipients, or to one or more social media platforms. The database 18 further stores the identities, credentials, states where licensed, contact information (e.g., address, email address, and mobile telephone number), and other information of lawyers licensed in various jurisdictions who have been vetted and contracted to be on call during certain days, time periods, and other work parameters to provide mobile lawyer services. The system 10 further includes a dash-mounted display monitor 20 such as a display integrated with the vehicle's dashboard, or a display device mounted on the dash. Alternatively, any display screen that is deployed within or on the vehicle may be used as part of the Mobile Lawyer system. A user may download and install the Mobile Lawyer App 22 onto his mobile phone 24, or another mobile device, such as a wearable device (e.g., smart watch), for example. The Mobile Lawyer App 22 or its functionality may also be native to and integrated with the vehicle's computing system. The video camera(s) and display screen(s) may directly communicate wirelessly to one or more remote server 16 and one or more remote database 18 via the wireless/cellular/computer/satellite network using communication capabilities native to the vehicle or via communication functionalities of the mobile device 24. It is contemplated that the drone may be controlled by administrators or other employees of the mobile lawyer service and/or the remote lawyer.

In operation, the user may initialize the Mobile Lawyer App 22 by setting up a profile with the name, address, phone number, age, sex, race, emergency contact, medical information, and other basic information. The user may become a subscriber by agreeing to make monthly subscription payments to retain the on-demand services provided via the Mobile Lawyer App 22. There may be multi-tiered services available tied to different subscription payment amounts. For example, the user may enter into an agreement to pay $9.99 per month for the basic service level and $29.99 per month for a premium service level. The service levels may differ in the amount of coverage in terms of, e.g., hours and jurisdiction. Once becoming a subscriber, the user is issued one or more stickers or decals that can be displayed on the vehicle (on the bumper, in the rear window, in the driver side window, etc.) to clearly mark and identify the user/driver as one that is protected by the Mobile Lawyer App 22.

The user may initiate a Mobile Lawyer Consultation Session and live-stream video capture by the camera(s) by sending a request via the Mobile Lawyer App 22. The initiation request may be triggered by pressing a button on a mobile device, buttons on a vehicle touch-sensitive display, a soft-key, a voice prompt (voice recognition), biometric verification (e.g., fingerprint, facial recognition, voiceprint, etc.), image recognition (e.g., automatic recognition of police vehicle) or a combination thereof. Alternatively, in service offerings that provide on-demand accident consultation, the vehicle (or the user's mobile device or wearable device) may automatically sense the occurrence of an accident, and automatically initiate a consult request. The initiation request may cause the one or more video cameras to immediately begin capture and transmit video images to the remote server and database. Alternatively, active on-going image capture and analysis of the vehicle exterior images may automatically recognize police vehicle, police uniform, police badge, and/or other characteristics associated with law enforcement personnel, and trigger activation of the Mobile Lawyer functionality upon detection of the presence of police personnel and/or vehicle.

Once the request to initiate the consult and live-stream video is received at the remote server, the database is searched to identify lawyers who are licensed in the jurisdiction where the user/driver is currently located. An alert notification is sent to one or more lawyers licensed in the same jurisdiction as the current location of the user using known contact information such as telephone number, mobile phone number, email address, instant messaging handles on messaging platforms, and other communication methods now known or to be developed. The alert notification may be in the form of a call, text message, email, and/or another form of notification transmitted to and presented on a computing device 26, such as a mobile phone, tablet computer, laptop computer, and desktop computer that is equipped or accessorized with a video camera. The first lawyer who responds to handle the consultation session can immediately view the live-streamed video information on a computing device. One or more additional criteria may also be used to select the responding lawyer such as highest rated, licensed longest, specific location, etc. as specified by the user. In a preferred embodiment, the lawyer interfaces with the system 10 via a web browser-based interface. As soon as a lawyer is selected and assigned to handle the consultation session, his/her image as captured by his/her computing device 26 (transmitted via the cloud 14) along with his/her name are displayed on the display of the user's mobile device, the dash-mounted monitor in the user's vehicle, and/or the dash-integrated display screen. In another alternate embodiment, a still image of the selected lawyer stored in the database may be displayed on one or more of the display screens if the lawyer is not able to participate via video.

The Mobile Lawyer App 22 has GPS and mapping capabilities (such as Android Location Services and Apple Location Services), or alternatively has access to these functions of the mobile phone, and/or the vehicle, so that it may be able to pinpoint the location of the user and relay this information to the server 16 so that this location information may be used in selecting lawyers who may respond to the alert notification. When GPS is not available or is not optimal, location may be determined by triangulation of cellular towers that are in communication with the user's mobile device or another location determination technology such as Google Location Services. The Mobile Lawyer system and method may use other positioning technology now known or to be developed. It should be noted that the location determination may be made by the mobile device, the vehicle's computing system, at the server, or a combination of two or more computing devices.

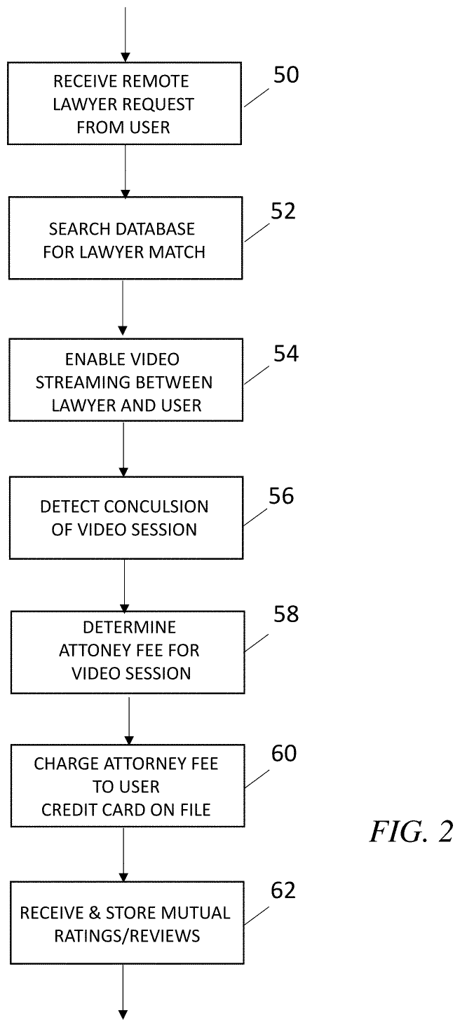

Referring to FIG. 2, a simplified flowchart of the mobile lawyer system and method is shown. In block 50, a request from the user is received by the mobile device to execute the Mobile Lawyer App. For example, the user may click a button, use a verbal command, or turn on the 360-degree camera to initiate the consultation session. As described above, active on-going video image capture and analysis may automatically initiate the consult session upon recognition of police vehicle or personnel in close proximity of the vehicle. The video camera(s) begins to capture video images inside and outside the vehicle and transmits the captured images in real-time to the remote server and database for storage. A determination is made as to the location of the user/vehicle, such as the city and state, and the remote database is searched for a lawyer licensed in the same jurisdiction, as shown in block 52. In response to the location of the user (i.e., jurisdiction), and possibly other criteria (e.g., seniority, experience, ranking, approval rating, and/or closest proximity to the user), one or more lawyers are selected and alerts are transmitted to their respective computing devices. One or more responses are received from the alerted lawyers, and one is selected. This selection may be done by the system automatically based on some predetermined criteria or the user may be provided the opportunity to select a lawyer. In the latter implementation, the photos and names of the lawyers may be displayed on the screen to enable the user to make a selection. In this example, if the user fails to make a selection, the system may automatically make the selection and begin the consult session.

The captured video data of the user is immediately transmitted to the selected lawyer's associated computing device, and the selected lawyer's computing device also captures video images of the lawyer and transmits it to the remote server, which in turn streams it to the display monitor located or mounted inside the user's vehicle (or on the user's mobile device), as shown in block 54. Audio data captured of the lawyer are also transmitted to the vehicle's or the mobile device's speaker system. In this manner, the lawyer has become a third-party observer in a police encounter and a video of the police encounter is automatically captured and recorded. In blocks 56-60, the Mobile Lawyer system and method detect a conclusion of the consult session, such as input from either or both the user and the lawyer, and a consultation fee for the session may be assessed and charged to the user's credit card on file. Alternatively, in subscription-based services model (either based on a specific user or on a specific vehicle or a vehicle fleet (e.g., delivery trucks, taxi cabs, transportation fleet, rental car fleet, etc.), fees for each consultation session are not assessed in addition to the subscription fees. In block 62, the user and the lawyer may rate each other and provide comments.

The following is an exemplary scenario in which the Mobile Lawyer App 22 can be used. The user, driving his car, sees that a police squad car is behind him with its lights flashing. The user pulls the car to the side of the road, and upon stopping the car completely, immediately clicks on the Mobile Lawyer App icon displayed on the screen of his mobile phone 24 to execute the app. Alternatively, the Mobile Lawyer App 22 can be initiated by other means, such as by a verbal command, biometric detection, image recognition of the police vehicle, and/or by turning on one or more video camera. The user may also connect the mobile phone to the video cameras and optionally to the vehicle's integrated display screen (via wireless or wired connections). The execution of the Mobile Lawyer App 22 automatically turns on the video camera 12 and begins live-streaming video data to the remote server. The server 16 also receives the request from the user and selects one or more licensed lawyers to send an alert notification. The notification may be done via the attorney's own mobile phone or computer, in the form of text message, a phone call, or another form of alert. The first lawyer(s) who responds immediately has access to the live-streaming video data of the scene. Additionally, the lawyer's video or still image is also immediately displayed on the dash-mounted monitor 20. Alternatively, the same can be displayed on the screen of the mobile phone. Because the video camera(s) are mounted or positioned to optimally capture the actions of the user/driver as well as the police officer that steps up to the car and standing by the driver's side door, the remotely-located lawyer can clearly see what is happening and the actions of any passenger in the car and activities that occur around the vehicle can be clearly captured. The lawyer's speech can be played over the user's devices and/or the vehicle's speaker system. The lawyer's image displayed on the screen is identified by name and other information that clearly identifies him/her as a licensed attorney for the jurisdiction in which the user is located. The licensed attorney can have a 360-degree view of the scene by accessing the live streamed video from the video camera. Video data from additional camera angles from above and other vehicle-mounted and/or drone-mounted cameras are also live-streamed to the lawyer's computing device. The live-streamed video is, at the same time, stored in the cloud data storage 18.

As soon as the lawyer and the user are connected, the lawyer may greet the user and provide the user some assurances. By the time the police officer steps up to the driver's side window, the display screen 20 shows the attorney's face and identification, and the video camera is capturing and live streaming video data. When the police officer first comes into view, the lawyer may choose to introduce him/herself to ensure that the police officer is aware of his/her presence. During the interaction between the police officer and the user, the attorney may remain silent and only act as an observer to allow the police officer to do his/her job without interference or obstruction. However, the lawyer may interject if and when the situation demands it, such as when the police officer's demand or action is illegal under the laws of that jurisdiction. The lawyer may also provide guidance to the user to cooperate with the police officer and serve as a calming influence in a scenario that may be tense for all parties involved.

From the vantage point of the police officer, the presence of the lawyer as a third-party observer may also serve to alleviate concerns he/she may have about the user/driver and remove some of the tension. The police officer may be assured that the presence of the Mobile Lawyer means that the user will likely be compliant and not resist his reasonable demands. Further assurance is the fact that there will be an additional comprehensive video recording of the incident that can be used to verify either party's testimony.

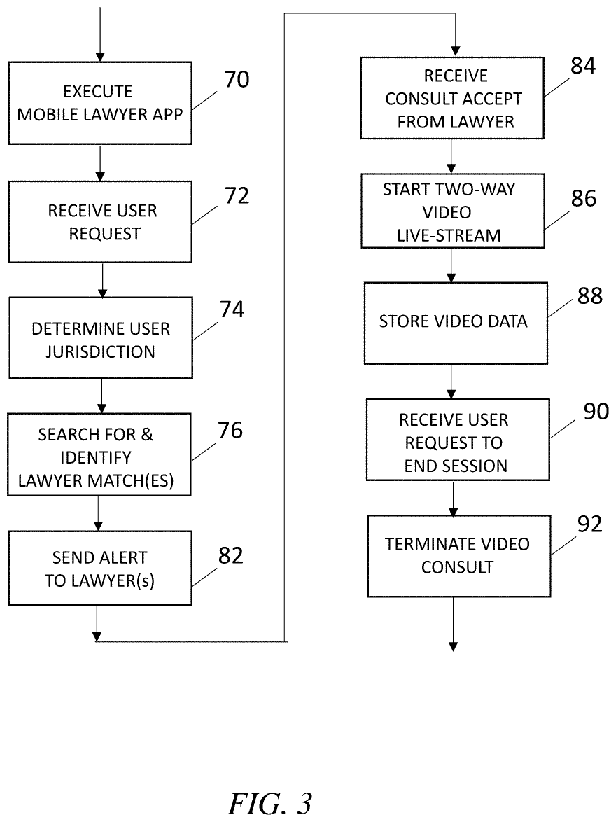

FIG. 3 is a more detailed flowchart of the Mobile Lawyer system and method. In block 70, the Mobile Lawyer app may execute either on the user's mobile device or in the vehicle's computing system. In an alternate embodiment, components of the Mobile Lawyer system and method may execute in both the vehicle's computing system and the user's mobile/wearable device and cooperate for some functionalities. In block 72, a request from the user is received to initiate the live consult and video-streaming session. For example, the user may click a button, use a verbal command, or turn on the 360-degree camera to initiate the consultation session. As described above, active on-going video image capture and analysis may automatically initiate a live mobile lawyer consult session upon recognition of a police vehicle or police personnel in close proximity of the user's vehicle. For example, the image recognition function may determine that a police vehicle with flashing lights is parked immediately behind the user's vehicle. Upon initiating the consult session, the video camera(s) automatically begins to capture video images inside and outside the vehicle and transmits the captured images in real-time to the remote server and database for storage. In blocks 74 and 76, a determination is made as to the location of the user/vehicle, such as the city and state, and the remote database is searched for a lawyer licensed in the same jurisdiction. The location determination may be made in the mobile/wearable device and/or the remote server. For example, the mobile device, using Android Location Services, determines the latitude and longitude (along with a timestamp) of the mobile device, which is transmitted to the server, which then uses that information to identify the city, county, state and/or zip code of the user's location. In response to the location of the user (i.e., jurisdiction), and possibly other criteria as previously indicated by the user (e.g., seniority, ranking, or rating of the lawyers), one or more lawyers are selected and alerts are transmitted to their respective computing devices, as shown in block 82. In block 84, one or more responses are received from the alerted lawyers, and one is selected (either based on a predetermined user-specified criteria or by the system). The captured video data is immediately streamed to the selected lawyer's associated computing device, and the selected lawyer's computing device also captures video images of the lawyer and transmits it to the remote server, which in turn streams it to the display monitor located or mounted inside the user's vehicle (or on the user's mobile device), as shown in block 86. Audio data captured of the lawyer are also transmitted to the vehicle's or the mobile device's speaker system. The two-way videos are automatically stored in the remote database, as shown in block 88. In this manner, the lawyer has become a third-party observer in a police encounter and a video of the police encounter is automatically captured and recorded. In blocks 90 and 92, the Mobile Lawyer system and method detect a conclusion of the consult session, such as input from either or both the user and the lawyer, and the consultation session is terminated.

The Mobile Lawyer app also includes a number of attorney functions that may be used by the lawyer during and after the consultation session. For example, the lawyer may use a note taking function to take down contemporaneous notes regarding his/her observation of the activities, such as writing down the police officer's name, badge number, and precinct. The attorney functions may also include capturing and storing of the video of the attorney in cloud storage. Additionally, when the action of the police officer is improper and exceeds the limits of legality, the lawyer may access and complete a police complaint report that may auto-fill certain data fields such as the date, time, and address/location of the stop, etc. In implementations where the Mobile Lawyer app may be equipped with image recognition and voice recognition capabilities to automatically determine the police officer's name, badge number, and vehicle license tag. A still image of the police officer may also be captured for inclusion with the police complaint report.

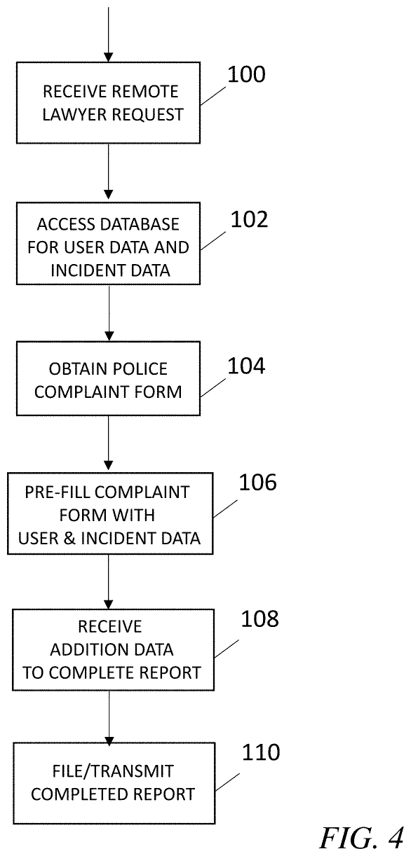

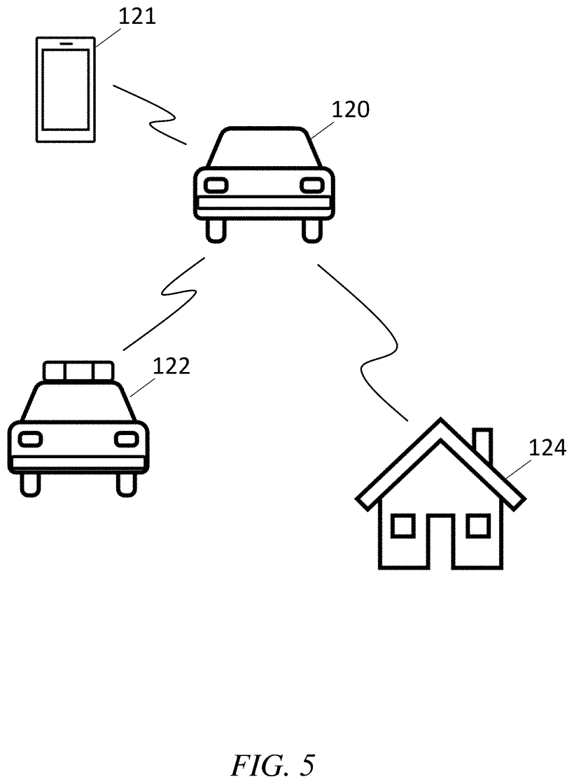

Referring to FIG.4, the mobile lawyer may request to access a police complaint function, as shown in block 100. The remote server accesses the database to obtain data associated with the user, as well as data related to the incident, as shown in block 102. The server also obtains a template police complaint and pre-fills certain data fields with user data and incident data, as shown in blocks 104 and 106. For example, data fields such as user's name, driver's license number, home address, age, sex, incident date, incident time, incident location, police officer name, badge number, and precinct can be pre-filled on the complaint form. The layer may then complete the complaint form online or on a downloaded copy, so that it may be completed and submitted to the proper authorities to lodge a complaint, as shown in blocks 108 and 110.

It should be noted that the police complaint report function can also or instead be made available to the user for filing complaints against a police officer. Similar data field pre-filling capability may also be deployed for filing court documents by the lawyer or the user, such as when defending a traffic citation.

FIG. 5 illustrates another embodiment of the Mobile Lawyer system and method according to the teachings of the present disclosure. In this embodiment, a component of the Mobile Lawyer system may execute in police vehicle's computing systems 122 that is capable of communicating with the Mobile Lawyer app executing in the user's mobile device 121, wearable device, and/or vehicle's computing system 120. The Mobile Lawyer app executing in the user's devices/vehicle is constantly monitoring for and is capable of detecting the presence of Mobile Lawyer system components executing in police vehicles. Alternatively, the Mobile Lawyer system components in the user's devices/vehicle is instructed to communicate with any Mobile Lawyer system component onboard police vehicles when they are within a certain distance with one another. This interaction enables the user and police officer to exchange basic profile information without close physical proximity. For example, at a police stop, the police officer is able to view on a display screen, a headshot, name, birthdate, address, and driver's license number of the user. In turn, the user is able to view the headshot, name, badge number, and precinct of the police officer. This car-to-car communication link may also enable the police officer to ask the user basic preliminary questions without being physically proximate to the user. The police officer and the user may also enable the exchange of live video feed of each other so that the officer may observe the current state of the user to make basic assessments. At the same time, this exchange between the user and the police officer can be observed and monitored by the lawyer 124 identified and selected for the live consult, and a still image or live video of the lawyer may also be displayed in the user's and police officer's respective display devices. Based on this initial interaction and observation, the police officer may decide whether it is necessary to approach the user's vehicle to make further inquiries and closer observations.

The Mobile Lawyer system and method may further include system components that execute in at least one of the user's mobile/wearable device and system components that execute in the user's vehicle computing system. These Mobile Lawyer system components may communicate and interact in additional ways to ensure the safety of the user. For example, the component executing in the user's smart watch may be able to monitor and track the user's location relative to the user's vehicle. This location information may be used by the system to adjust the field of view of the video camera(s) so that it may continue to capture video images of the user even if the user is behind the vehicle, for example. The system components may also be able to detect increased distance between the user and the user's vehicle for a certain time period, and to automatically transmit the real-time locations of the user and the vehicle to the lawyer, and to one or more pre-set recipients (e.g., a family member, close friend, or tow truck company). This scenario may be useful where the user is separated from the vehicle because the user is being detained and the user's vehicle is being left by the side of the road.

It is the hope that the Mobile Lawyer technology described herein can provide a desperately needed calming and tempering presence that can be called upon whenever a police encounter occurs. Not unlike having a legal adviser ride-along at all times, the Mobile Lawyer can be summoned to serve, observe, and provide legal guidance to the user in tense situations.

The lawyer selection criteria are primarily jurisdictional due to the licensing requirements for lawyers. However, other selection factors may be used such as the attorney's rankings, approval ratings, service history, seniority, etc. Secondarily, users may rate lawyers and those lawyers with poor rating may receiver fewer or no opportunities to respond to consultation requests.

It should be noted that 360-degree camera described herein can be any camera that provides a wide field of view or a substantially panoramic field of view, and can include a single lens or multiple lenses. Multi-lens cameras capture multiple video streams that are stitched together by software. The term 360-degree camera should not be interpreted herein to strictly include cameras that capture exactly 360-degrees field of view. The “360-degree camera” can be stand-alone or built-into the mobile device and/or the vehicle, and can be in one housing or multiple housings. The output 360-degree video can be the result of multiple video streams stitched together to form the 360-degree view.

It should be noted that it is contemplated herein that the functionalities of the video camera and display monitor can be combined and integrated into one housing, so that one integrated device is dash-mounted with video camera and display capabilities, as well as communicating with the remote server, either directly via the Internet/cellular network or through the user's mobile device. Moreover, the image capture and display functionality may be entirely disposed on the user's mobile device, on a dash-mounted accessory device, on a vehicle-integrated OEM device, or a combination thereof. The advancement of capabilities of computing and communication powers of computing device on-board today's vehicles makes it possible to incorporate all or most of the Mobile Lawyer app functionality into the vehicle's computing functionalities. Moreover, although the current system and method have been described in the context of a vehicle, the concepts are applicable to police encounter situations where the user is not driving or riding in a vehicle.

It should be understood that user's profile data, subscription information, and video data are protected by password and other security measures. Further, the lawyers' profile and credential information are also protected by password and other security measures. To access these data, the users and lawyers must supply the correct login information. It should be noted that the terms “video,” “video data,” and “video images” are used herein to refer to moving visual image data that preferably includes audio data, but may not include audio data or may include only intermittent audio data.

It is contemplated that in offerings that provide on-demand accident consultation, the Mobile Lawyer system and method is in communication with the vehicle (or the user's mobile device or wearable device) that may automatically sense the occurrence of an accident due to accelerometer sensors present in the vehicle (and the user's mobile and wearable devices) so that the mobile lawyer system/method may automatically initiate a consult request to one or more lawyers licensed in the same jurisdiction or one or more lawyers who are currently located in closest proximity to the vehicle.

The features of the present invention which are believed to be novel are set forth below with particularity in the appended claims. However, modifications, variations, and changes to the exemplary embodiments described above will be apparent to those skilled in the art, and the system and method for Mobile Lawyer described herein thus encompasses such modifications, variations, and changes and are not limited to the specific embodiments described herein.

What is claimed is:

1. A mobile lawyer method, comprising:
receiving a live consultation request from a user;
automatically receiving a live-stream of video images of the user and surroundings and storing the video images;
automatically searching a plurality of information records associated with a plurality of lawyers stored in a remote database;
automatically identifying at least one lawyer licensed in a jurisdiction that corresponds to a current location of the user;
automatically transmitting at least one notification to at least one computing device associated with the identified at least one lawyer;
live-streaming captured video images of the user to the at least one computing device associated with the identified at least one lawyer for displaying and viewing by the identified at least one lawyer;
automatically receiving and storing live-streaming video images of the identified at least one lawyer in the remote database; and
automatically transmitting the live-streaming video images of the identified at least one lawyer to be displayed on a display screen viewable by the user.

2. The mobile lawyer method of claim 1, wherein automatically receiving a live-stream of video images of the user and surroundings comprises automatically receiving video images captured by at least one video camera selected from the group consisting of a video camera mounted on a drone, a front-facing camera native to the mobile device, a back-facing cameras native to the mobile device, a camera native to a wearable device, a camera integrated with a vehicle, a camera mounted in an interior position of a vehicle, a camera mounted at an exterior position of a vehicle, a camera with infrared capabilities, and a 360-degree video camera.

3. The mobile lawyer method of claim 1, wherein receiving a live consultation request from the user comprises receiving at least one of receiving a button click, a voice command, a biometric verification trigger, an image recognition trigger, and a sensory trigger.

4. The mobile lawyer method of claim 1, further comprising receiving the current location of the user determined by at least one of GPS, cellular tower triangulation, Android Location Services, Apple Location Services, and Google Location Services.

5. The mobile lawyer method of claim 1, further comprising selecting a lawyer having the highest approval rating.

6. The mobile lawyer system of claim 1, further comprising automatically pre-fill a plurality of data fields of a complaint report including data selected from the group consisting of user's name, user's driver's license number, birthdate, home address, incident date, incident time, incident location, police officer's name, and police officer's badge number.

7. The mobile lawyer method of claim 1, wherein automatically transmitting the live-streaming video images of the identified at least one lawyer to be displayed a display screen viewable by the user comprises at least one display screen selected from the group consisting of a display screen native to the mobile device, a display screen native to a wearable device, a display screen integrated with a vehicle, a display screen mounted in an interior position of a vehicle, and a display screen mounted at an exterior position of a vehicle.

8. The mobile lawyer method of claim 1, further comprising assessing at least one of a subscription fee and a per-session fee.

9. A mobile lawyer method, comprising:
receiving a live consultation request from a user;
automatically initiating capture of video images of the user and surroundings in response to the consultation request, and transmitting the captured video images to a remote database for storage;
automatically receiving an identification of at least one lawyer licensed in a jurisdiction that corresponds to a current location of the user, wherein the at least one lawyer is identified by searching a plurality of records associated with a plurality of lawyers stored in a remote database;
automatically receiving captured video images of the identified at least one lawyer after the identified at least one lawyer received and accepted a notification transmitted to at least one computing device associated with the identified at least one lawyer;
automatically displaying the video images of the identified at least one lawyer for viewing by the user; and
continually capturing and transmitting the video images of the user and surroundings for storage and viewing by the identified at least one lawyer.

10. The mobile lawyer method of claim 9, wherein automatically initiating capture of video images of the user and surroundings comprises automatically initiating a capture of video images by at least one video camera selected from the group consisting of: a video camera mounted on a drone, a front-facing camera native to the mobile device, a back-facing cameras native to the mobile device, a camera native to a wearable device, a camera integrated with a vehicle, a camera mounted in an interior position of a vehicle, a camera mounted at an exterior position of a vehicle, a camera with infrared capabilities, and a 360-degree video camera.

11. The mobile lawyer method of claim 9, wherein receiving a live consultation request from the user comprises at least one of receiving a button click, a voice command, a biometric verification trigger, an image recognition trigger, and a sensory trigger.

12. The mobile lawyer method of claim 9, further automatically determining a location of the user by at least one of GPS, cellular tower triangulation, Android Location Services, Apple Location Services, and Google Location Services.

13. The mobile lawyer method of claim 9, further receiving a user input selecting a lawyer from a plurality of lawyers licensed in a jurisdiction that corresponds to a current location of the user.

14. The mobile lawyer method of claim 9, further comprising providing secured access by the remote lawyer to user data and incident data comprising user's name, user's driver's license identifier, home address, birthdate, incident date, incident time, and incident location, police officer's name, and police officer's badge number.

15. The mobile lawyer method of claim 9, further comprising automatically pre-filling certain data fields of a police complaint report with data obtained from the database, including user's name, user's driver's license identifier, home address, birthdate, incident date, incident time, and incident location, police officer's name, and police officer's badge number.

16. The mobile lawyer method of claim 9, wherein automatically displaying the video images of the identified at least one lawyer comprises displaying the video images on at least one display screen selected from the group consisting of a display screen native to the mobile device, a display screen native to a wearable device, a display screen integrated with a vehicle, a display screen mounted in an interior position of a vehicle, and a display screen mounted at an exterior position of a vehicle.

17. The mobile lawyer method of claim 9, further comprising assessing at least one of a subscription fee and a per-session fee.

18. A mobile lawyer method, comprising:
receiving a live consultation request from a user inside a vehicle;
automatically receiving a current location of the vehicle;
automatically receiving a live-stream of video images of the user and surroundings and storing the video images;
automatically searching a plurality of records associated with a plurality of lawyers stored in a remote database;
automatically identifying at least one lawyer licensed in a jurisdiction that corresponds to the current location of the vehicle;
automatically transmitting at least one notification to at least one computing device associated with the identified at least one lawyer;
receiving an acceptance from the identified at least one lawyer;
selecting a lawyer from the at least one lawyer who accepted the live consultation request;
live-streaming captured video images of the user to a computing device associated with the selected lawyer for displaying and viewing by the selected lawyer;
automatically receiving and storing live-streaming video images of the selected lawyer in the remote database;
automatically transmitting the live-streaming video images of the selected lawyer to be displayed on a display screen viewable by the user, the display screen selected from the group consisting of a display screen native to a mobile device, a display screen native to a wearable device, a display screen integrated with the vehicle, a display screen mounted in an interior position of the vehicle, and a display screen mounted at an exterior position of the vehicle; and
continuing to receive and store live-stream video images of the user and surroundings, transmitting the live-stream video images to the computing device associated with the selected lawyer for displaying and viewing by the selected lawyer.

19. The mobile lawyer method of claim 18, further comprising:
communicating with a police vehicle that is located in close proximity to the user's vehicle;
transmitting to the police vehicle information associated with the user;
receiving, from the police vehicle, information associated with a police officer operating the police vehicle;
displaying, for viewing by the user, the information associated with the police officer.

20. The mobile lawyer method of claim 18, further comprising:
determining and monitoring a real-time location of the user;
determining the real-time location of the user exceeds a threshold distance from the current location of the user's vehicle; and
transmitting an alert to at least one recipient in response to determining the threshold distance being exceeded, the alert including the current location of the vehicle and the real-time location of the user.
